(19) United States
(12) Patent Application Publication
(10) Pub. No.: US 2012/0179479 A1
(43) Pub. Date: Jul. 12, 2012

(54) Method and System for Remote Tele-Health Services

(76) Inventors: VINCENT WATERSON, Ventura, CA (US); David Sturgess, Chesterfield (GB)

(21) Appl. No.: 12/987,618

(22) Filed: Jan. 10, 2011

(51) Int. Cl. G06Q 50/00; G06Q 10/00

(52) U.S. Cl. 705/2

(57) ABSTRACT

A method and system includes an enclosure comprising a plurality of vital signs monitoring devices, a patient chair comprising a plurality of medical sensors, a weight scale, a height measurement device, a video monitor and a first camera for videoconference calls. A second camera is for skin and orifice inspection. A sanitization device sanitizes air and interior surfaces of the cabin. An air management device is operable for sanitizing air entering the cabin. A door has an electrically operated lock. Contaminates on a floor of the cabin are detected. Sanitation of the cabin is initiated. A patient is admitted into the cabin. A videoconference is initiated between the patient and a remote medical practitioner at a medical call center. Data is captured and transmitted to the remote medical practitioner for diagnosis. Prescriptions are processed for the patient. Additional test requests for the patient are processed.

### CROSS-REFERENCE TO RELATED APPLICATIONS

The present Utility patent application claims priority benefit of the U.S. provisional application for patent Ser. No. 61/262,146 filed on Nov. 18, 2009 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to medical health care technology. More particularly, the invention relates to providing remote tele-health services.

### BACKGROUND OF THE INVENTION

Conventional medical services and care are experiencing increased demand as a result of the increasing age of the population. Additionally, medical care is becoming increasingly more expensive and unavailable for a large portion of the population.

Prior Art includes United States Patent Application 20100222649 claims. An engagement is brokered between a consumer and a medical service provider; a request from a user to consult with a medical service provider having a service provider profile that satisfies at least some attributes in a set of attributes that define a suitable service provider is received in a server computer system; an available medical service provider satisfying at least some of the attributes in the set of attributes is identified; a communication channel is provided to establish an electronic, real-time communication between the user and the medical service provider; a measurement from a sensor configured to measure a physiological parameter of the user is received over the communication channel. This method requires the consumer to own vital signs monitoring devices and be proficient in their use and to also have access to a broadband internet system and own a computer with interfaces which will support connection of these devices.

Prior Art includes U.S. Pat. No. 5,441,047 claims. An ambulatory (in the home) user health monitoring system is disclosed wherein the user is monitored by a health care worker at a central station, while the user is at a remote location. The user may be a person having a specific medical condition monitored or may be an elderly person desiring general medical surveillance in the home environment. Cameras are provided at the user's remote location and at the central station such that the user and the health care worker are in interactive visual and audio communication. A communications network such as an interactive cable television is used for this purpose. Various medical condition sensing and monitoring equipment are placed in the user's home, depending on the particular medical needs of the user. The user's medical condition is measured or sensed in the home and the resulting data is transmitted to the central station for analysis and display. The health care worker then is placed into interactive visual communication with the user concerning the user's general well being, as well as the user's medical condition. Thus, the health care worker can make “home visits” electronically, twenty-four hours a day.

Prior Art includes U.S. Pat. No. 7,778,852 claims. A remotely programmable and accessible medical device system including an interface unit and a medical device connected to a user is disclosed. Through a transceiver, such as a telephone or computer, a person may obtain status reports from a remotely located medical device in audible, electronic or paper form. In addition, the person may change a protocol associated with the medical device or be alerted at a remote location of an alarm associated with the medical device.

In view of the foregoing there is need for systems for providing affordable and accessible health care. What is needed is a remotely accessed tele-health system providing a plurality of vital signs monitoring devices in a secure, sanitized public access cabin connected to a Medical Call Center (MCC). Users of a tele-health system may be provided with convenient and affordable access to primary healthcare without having to travel a significant distance for care.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 presents an example illustration of a tele-health system, in accordance with an embodiment of the present invention;

FIG. 2 presents an example schematic illustration for a system associated with the tele-health cabin described with reference to FIG. 1, in accordance with an embodiment of the present invention;

FIG. 3 presents an example illustration of a folding seat located within a tele-health cabin, in accordance with an embodiment of the present invention;

FIG. 4 presents an example illustration of a system of electronic components associated with tele-health cabin as described with reference to FIG. 1;

FIG. 5 presents an example schematic illustration of a tele-health system, in accordance with an embodiment of the present invention;

FIG. 6 illustrates a typical computer system that, when appropriately configured or designed, may serve as a computer system 600 for which the present invention may be embodied; and

FIGS. 7A-D present a flow chart illustrating an exemplary method 700 for interaction with the elements as described with reference to FIGS. 1-6, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a method and system for remote tele-health services is presented.

In one embodiment a method includes the steps of determining an occupancy status of a cabin comprising an enclosure comprising a plurality of vital signs monitoring devices including a blood pressure cuff, a temperature monitor, a spirometer, and an oximeter, a patient chair comprising a plurality of medical sensors including a stethoscope, and an electrocardiograph, a weight scale, a height measurement device, a first video monitor for videoconference calls, a first camera for the videoconference calls, a second camera for skin and orifice inspection, a sanitation device for sanitation of air and interior surfaces of the cabin, an air management device operable for sanitizing air entering the cabin, a presence detector, and a door having an electrically operated lock. The cabin is operable for facilitating health care services. Contaminates on a floor of the cabin are detected. A sanitation of the cabin using at least the sanitation device is initiated when the status is unoccupied and contaminates are detected. A patient is admitted into the cabin by unlocking and opening the door. A videoconference is initiated between the patient and a remote medical practitioner at a medical call center. Data is captured from the plurality of vital signs monitoring devices, plurality of medical sensors, the weight scale, and the height measurement device. The captured data is transmitted to the remote medical practitioner for diagnosis. Prescriptions are processed from the remote medical practitioner for the patient. Additional test requests by the remote medical practitioner for the patient are processed. The door is unlocked and opened at the end of the videoconference. The door is closed and locked when the status is unoccupied. Another embodiment further includes the steps of recognizing a card device of a patient, retrieving information from the card device, transmitting at least a portion of the information to the medical call center, and storing results of the diagnosis on the card device. Yet another embodiment further includes the steps of obtaining medical information from the patient via a terminal adjacent to the cabin and transmitting the information to the medical call center. Still another embodiment further includes the steps advising the patient on the availability of the cabin. Another embodiment further includes the steps notifying the patient that the cabin is available. Yet another embodiment further includes the steps of controlling positioning of the medical sensors in the patient chair in response to commands received from the remote medical practitioner. Still another embodiment further includes the steps of displaying an instructional video to the patient. In another embodiment the step of initiating a sanitization further includes notifying a cleaning attendant.

In another embodiment a system includes a cabin comprising: an enclosure with a door having an electrically operated lock, means for monitoring vital signs, means for positioning a plurality of medical sensors including a stethoscope, and an electrocardiograph, means for weighing a patient, means for measuring a height of a patient, means for videoconferencing with a remote medical practitioner, means operable for skin and orifice inspection, means operable for detection of contaminants located on a floor of the cabin, means operable for sanitation of air and interior surfaces of the cabin, means operable for sanitizing air entering the cabin, means for detecting a patient within the cabin, and means for controlling the cabin and capturing patient data from the cabin. A medical call center includes means for graphically displaying patient data on a three-dimensional representation of a patient. The system further includes means for bi-directional communication between the controlling means and the medical call center enabling the controlling means to transmit the patient data to the medical call center for display on the displaying means to the remote medical practitioner and enabling the remote practitioner to videoconference with a patient in the cabin where the remote medical practitioner can diagnosis symptoms of the patient.

In another embodiment a system includes a cabin including an enclosure with a door having an electrically operated lock. A plurality of vital signs monitoring devices is disposed within the enclosure. The plurality of vital signs monitoring devices including a blood pressure cuff, a temperature monitor, a spirometer, and an oximeter. A patient chair, disposed within the enclosure, includes a motorized seat back operable for positioning a plurality of medical sensors including a stethoscope, and an electrocardiograph. A weight scale weighs a patient. A height measurement device measures a height of a patient. A first video monitor, disposed within the enclosure, is for videoconference calls to a remote medical practitioner. A first camera, disposed within the enclosure, is for the videoconference calls. A second camera, disposed within the enclosure, is operable for skin and orifice inspection. A contaminant detection system, disposed within the enclosure, is operable for detection of contaminants located on a floor of the cabin. A sanitation device, disposed within the enclosure, is operable for sanitation of air and interior surfaces of the cabin. An air management device is operable for sanitizing air entering the cabin. A patient presence detector, disposed within the enclosure, is for detecting a patient within the cabin. A cabin management unit, disposed within the enclosure, is for controlling the cabin and capturing patient data from the cabin. A medical call center includes a second video monitor for graphically displaying patient data on a three-dimensional representation of a patient. A communication link is for bi-directional communication between the cabin management unit and the medical call center enabling the cabin management unit to transmit the patient data to the medical call center for display on the video monitor to the remote medical practitioner and enabling the remote practitioner to videoconference with a patient in the cabin where the remote medical practitioner can diagnosis symptoms of the patient. In another embodiment the cabin further comprises a card device reader for reading information from the patient's card device. In yet another embodiment the cabin further comprises a terminal for obtaining medical information from the patient. In still another embodiment the cabin further comprises a reader for reading prescription containers. In another embodiment the cabin further comprises a security camera. In yet another embodiment the cabin further comprises pagers for notifying patients of availability of the cabin. In still another embodiment the cabin further comprises a panic button for activating an alarm. In another embodiment the remote medical practitioner is further enabled to control the motorized seat back for positioning the medical sensors. In yet another embodiment the remote medical practitioner is further enabled to unlock and open the door. In still another embodiment the floor comprises a pattern for facilitating detection of contaminants. In another embodiment the patient chair is foldable.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A first embodiment of the present invention will be described which provides means and methods for providing affordable healthcare service. User visit automation and efficient management of expensive medical personnel resources may be provided in order to reduce inefficiencies and waste in current healthcare systems. For example, efficiencies may be realized via out-patient services. Tele-health services may be provided for users to access on a “walk-in” basis. Furthermore, users may be provided access to a public tele-health cabin in order to benefit from efficiencies enabled by a digital healthcare system. Users may be provided access to a large pool of medical professionals via remote medical call centers. The fusion of satellite communications, advanced telemedicine devices and bi-directional video communications provided by tele-health cabins may provided via convenient access areas, such as supermarkets or gas stations. Furthermore, tele-health cabins may provide affordable health care to the public at large.

In other embodiments of the present invention, a mobile vehicle equipped with a video terminal and satellite communications capabilities may be maneuvered to remote areas providing medical care in geographic regions not capable of supporting independent medical personnel.

In other embodiments of the present invention, tele-health cabin units may be located in areas or facilities providing senior members of society with convenience, travel cost savings, and economical healthcare.

An unmanned, cost effective walk-in tele-health cabin may be provided for enabling users to remotely consult with trained medical staff for a variety of common outpatient symptoms.

Tele-health devices and communications traffic engineering of call center staff may be provided in order for a multiplicity of users to communicate and collaborate with a finite resource of medical professionals. Benefits may include early detection and treatment of illness on a scale as to potentially reduce associated outpatient care costs. Furthermore, aggregate annual healthcare costs may be reduced by an associated reduction in the quantity of people visiting hospital emergency rooms for treatment for minor ailments. Tele-health cabins may be provided for wheelchair access and may be located in geographically convenient areas. Non-limiting examples of convenient locations include pharmacies located in supermarkets for more populated regions and in gas stations and other convenience retail establishments for rural populations. The service may also be provided using satellite to passengers and/or crew of ocean going vessels.

A telecommunications link may be defined as a “routable and switched” digital data connection which may operate to enable a remote consultation session to be established between a tele-health cabin and one of a multiplicity of terminals geographically located at one of a number of MCC's. A bi-directional communication channel may be established with sufficient bandwidth to carry data for a digital video conference between user/patient and health care provider. Furthermore, information may be simultaneously communicated for the various instruments and for other controlling functions. Non-limiting examples of communication methods include satellite, optical fiber, copper wires and other methods for communicating information bi-directionally. A connection may be established at the initiation of a consultation session, identified by insertion of a card device into a card terminal. A connection may also be established using a cellphone or other wireless devices such as an iPad. Furthermore, a session may be terminated by the removal of a card device.

In other embodiments of the present invention, tele-health cabins may be provided for users seeking primary healthcare where users may connect to hospital-based MCCs via a bi-directional telecommunications link where qualified nurse practitioners, doctors and other medical practitioners may provide face-to-face tele-health consultations.

Users of tele-health cabins may be provided with access to a multiplicity of vital signs monitors connected via bi-directional telecommunications video collaboration to staff geographically located at a MCC who may operate to analyze the user's/patient's health.

Tele-health cabins may be provided with a footprint small enough such that the tele-health cabins may be located in a supermarket or other convenient retail establishment. Furthermore, the footprints of tele-health cabins may be configured small enough such that valued retail space may not be compromised. Furthermore, tele-health cabins may be of sufficient size to accommodate up to two persons. Furthermore, tele-health cabins may provide a pre-sanitized sound reducing enclosure for ensuring a healthy environment while providing complete privacy during video consultations.

In other embodiments of the present invention, a system may be provided for linking tele-health cabins via a telecommunications channel with one or more regional hospitals or medical clinics. Furthermore, this structure may operate to provide facilities and medical personnel for providing MCC services per the specified needs of a particular user/patient.

In other embodiments of the present invention, primary health care services may be provided via tele-health cabins located in rural environments where it may not be viable to provide a mobile or fixed clinic staffed by medical personnel.

Tele-health services may be provided via supermarkets having pharmacies located in or adjacent to the supermarkets. Furthermore, tele-health services may be provided in geographically rural locations such as fire, ambulance or gas stations.

As an example, tele-health cabins may be situated in approximately 30 square feet of area. Furthermore, tele-health cabins may be acoustically insulated and provide equipment for a video conference terminal, a card device terminal, a multiplicity of vital signs monitors and a communication connection for a telecommunications link. A tele-health cabin may be equipped with a sanitization system for continually sanitizing the air and surfaces interior to the tele-health cabin. Furthermore, tele-health cabins may be configured for support of wheelchair access.

Services provided via tele-health cabins may be charged against a pre-paid card device. Card devices may be configured based upon a time required for service or based upon the type of service rendered.

Tele-health cabins may be equipped with a multiplicity of devices for measuring a user's/patient's vital signs. Non-limiting examples of devices for measuring vital signs include blood pressure, temperature and weight. Disposable probes may be provided for making contact with the various devices associated with a tele-health cabin. Tele-health cabins may operate unattended. Furthermore, users/patients of a tele-health cabin may operate to generate connections with vital sign monitors to their person under instructions from a medical professional who may be geographically located at a remote MCC.

Users seeking to use tele-health services may purchase a card device provided via convenient retail establishments. Non-limiting examples of retail establishments include supermarkets and gas stations. Furthermore, users may purchase disposable probes located at convenient retail establishments for later attachment to the tele-health equipment.

Users may opt to pay for a minimum consultation fee or purchase additional consultation time.

Users may initiate tele-health service using an e-check-in terminal located external to tele-health cabins. A user may insert a card device into an e-check-in terminal positioned on the exterior of the tele-health cabin. Furthermore, a user may enter personal medical information via a touch screen in response to an electronic questionnaire provided via a terminal device. Furthermore, a user may operate to use a code reader located near the e-check-in terminal in order to scan codes located on their prescription containers. Furthermore, prescription information may be stored on a user's/patient's card device.

Following completion of an electronic form provided via an e-check-in terminal, a user may be advised to enter tele-health cabin for services or a user may be advised to wait for the next available consultation. Furthermore, a user may be notified of an estimated wait time. Furthermore, a user may be notified with a recommendation to retrieve a paging device located in a nearby dispenser. Furthermore, a user may be notified via an external display and/or a paging device of the availability of a tele-health cabin.

Tele-health cabins may provide equipment for enabling an automated ultraviolet ion process for sanitizing the air and exposed surfaces associated with a tele-health cabin.

After entering a tele-health cabin, users/patients may sit on a seat located in front of a video conference device. Video conference device may be located on a wall adjacent to the entrance door. A user/patient may insert a card device associated with the video phone for initiating a video communications link with an MCC. Furthermore, associated user/patient medical details retrieved from the card device may be presented on a terminal geographically located at the MCC. A medical practitioner may then query the user/patient with questions associated with their medical condition. Furthermore, medical practitioner may request user/patient to create physical contact to their person with one or more tele-health devices provided via the tele-health cabin. Devices connected to the user/patient may communicate information via a communications link. Furthermore, communicated information may be displayed on the medical practitioner's display terminal. During the video consultation the medical professional may also conduct a visual examination of the user's extremities using a secondary camera connected to the tele-health cabin management system. Medical practitioner may also inspect the user's/patient's extremities for cuts, bruises etc.

In other embodiments of the present invention, capabilities may be provided for diagnostic services whereby a color analysis of the user's/patient's face and tongue may be used for performing a preliminary analysis of the user's health via a video consultation with a medical practitioner geographically located at an MCC.

At the termination of a consultation session, a medical professional may take a number of actions. As an example, the medical professional may transmit an electronic prescription to a pharmacy. Furthermore, the pharmacy may be conveniently located adjacent to the tele-health cabin. Furthermore, a copy of the prescription may be transmitted via a telecommunications link to the user's card device. Furthermore, as another example, the medical practitioner may transmit and store requests for additional tests to the user's/patient's card device. Non-limiting examples of additional tests include blood or specimen.

For additional testing, a user may perform testing at a participating testing laboratory where a card device may be inserted into a card terminal in order to transfer test request information to testing service. Following testing, the testing laboratory may transmit the test results to the card device. Furthermore, the test results may be communicated to the MCC via a telecommunications link. Following additional testing, user/patient may visit a tele-health cabin for a follow-on session during which the test results may be retrieved from the card device and transferred to the medical professional geographically located at the MCC for analysis. Alternatively, the medical professional may retrieve the test results communicated previously via a telecommunications link to the MCC.

A medical professional associated with the MCC may also recommend the user/patient receive further health care. As an example, an inoculation may be provided by a pharmacist located in an adjacent pharmacy. Furthermore, the medical professional may determine the user/patient needs further treatment not available via tele-health services and as a result may recommend the user/patient visit another medical professional participating in the tele-health network. Furthermore, the medical professional may determine the user needs urgent medical attention and as a result the medical professional may recommend the user/patient visit a nearby hospital or emergency room. Furthermore, in some situations, the medical practitioner may summon an ambulance to the user's/patient's geographic location.

At the termination of each tele-health visit the system may automatically transfer information to the user's card device. Furthermore, one or more coupons may be transferred to the user's card device for use in purchasing products associated with the user's medical condition (e.g. a coupon for cough mixture). Furthermore, the coupons may be associated with the supermarket or pharmacy associated with the tele-health cabin.

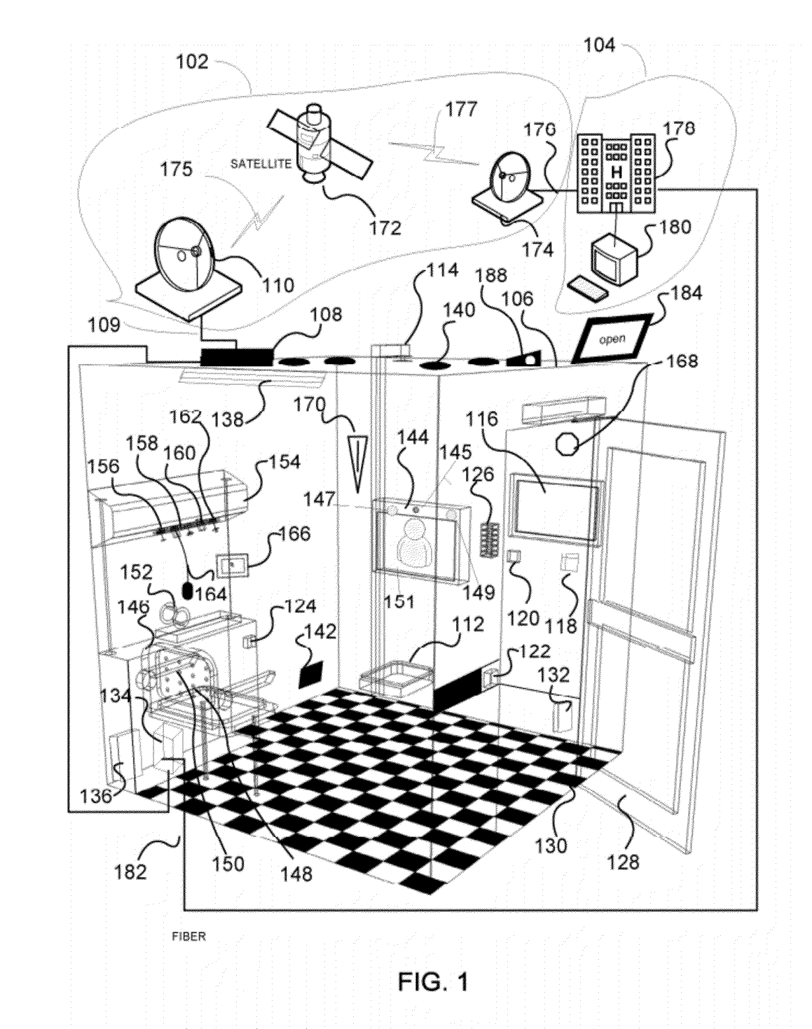

FIG. 1 presents an example illustration of a tele-health system, in accordance with an embodiment of the present invention.

A tele-health system 100 includes tele-health a satellite communications system 102, an MCC 104 and a tele-health cabin 106.

Satellite communications system 102 may operate to provide bi-directional communications between MCC 104, tele-health cabin 106 and other entities (not shown).

Should the cabin be installed in a location without “Uninterruptable Power” then an Uninterruptable Power Supply may be provided to maintain tele-health cabin operation in the event of local power loss.

MCC 104 may operate to provide healthcare services remotely. Non-limiting examples of services provided by MCC 104 include consultations with doctors, nurses and other qualified health care providers.

Tele-health cabin 106 may operate to provide an interface for users in order to receive services remotely. Non-limiting examples of services provided remotely includes health care consultations and other health care services.

Satellite communications system 102 includes a satellite antenna 110, a satellite 172 and a remote satellite teleport 174.

Satellite antenna 110 may operate to communicate bi-directionally with satellite via a communication channel 175. Satellite 172 may operate to communicate bi-directionally with remote satellite teleport 174 via a communication channel 177.

MCC 104 includes a processing system 178 and a remote terminal 180.

MCC 104 may operate to provide reception, transmission and processing of information. Non-limiting example of information processed includes health care information such as blood pressure, height and weight.

Remote terminal 180 may operate to provide a health care provider (not shown) with information associated with processing system 178.

Tele-health cabin 106 includes a satellite transceiver 108, a digital scale 112, a height measurement device 114, a terminal 116, a code scanner 118, a card terminal 120, a card reader 122, a card terminal 124, a vibrating page device 126, a door 128, a floor 130, a sanitization device 132, a cabin management system 134, an air management device 136, a light device 138, a cameras portion 140, an ultraviolet light 142, a video terminal 144, a seat 146, a stethoscope 148, an EKG equipment portion 150, a blood pressure cuff 152, a cabinet 154, a temperature monitor 156, an oximeter 158, a spirometer 160, a glucose monitor 162, a second camera 164, a small monitor 166, a presence detector 168, a coat hanger 170, a video display 184, a panic device 186 and a siren 188.

Video terminal 144 includes a video camera 145, a microphone 147, an audio portion 149 and a video display 151.

Video camera 145 may operate to capture and transmit video information. Microphone 147 may operate to capture and transmit audio information. Audio portion 149 may operate to inform user/patient via an audio means. Non-limiting examples of audio portion 149 include speakers, ear phones and head phones. Video display 151 may operate to present video information to a user/patient located internal to tele-health cabin 106.

Satellite transceiver 108 may operate to communicate bi-directionally with satellite devices. Digital scale 112 may operate to determine and communicate weight information. Height measurement device 114 may operate to determine and provide height information. Non-limiting examples of operational modes for height measurement device 114 includes sonar and laser.

Terminal 116 may operate to present information to a user. Non-limiting examples of uses for terminal 116 includes user/patient consultation initiation and presenting other user/patient associated information. Code scanner 118 may operate to receive and process code information. Non-limiting examples of code scanner 118 include bar code scanner.

Card terminal 120 may operate to receive, transmit and process information for a card device. Non-limiting examples of a card device include smart card, insurance card and driver's license

Card reader 122 may operate to receive, transmit and process information for a card device. Non-limiting examples of a card device include smart card, insurance card and driver's license.

Card terminal 124 may operate to receive, transmit and process information for a card device. Non-limiting examples of card device include smart card, insurance card and driver's license. Vibrating page device 126 may operate to inform or notify a user or patient of available tele-health cabin 106.

Door 128 may operate to provide a means for allowing entry and for enclosing tele-health cabin 106. Non-limiting examples of door 128 include electromechanically operated door. Floor 130 provides an area for a user to reside and provides a mechanism for performing sanitization. Sanitization device 132 may operate to provide sanitization of tele-health cabin 106.

Cabin management system 134 may operate to communicate with devices and sensors associated with tele-health cabin 106 and may communicate information with MCC 104. Air management device 136 may operate to manage sanitization of tele-health cabin 106. Light device 138 may operate to provide illumination of tele-health cabin 106. Cameras portion 140 may operate to provide detection and communication of unsanitary conditions for floor 130.

Ultraviolet light 142 may operate to provide illumination for cameras portion 140 for determining and communicating unsanitary conditions for floor 130.

Video terminal 144 may operate to display information to a user. Seat 146 may operate to provide user a device for residing in a sitting position. Seat 146 may operate to fold into a compact form. A non-limiting example reason for folding seat 146 to be oriented into compact form includes user access to the features provided by tele-health cabin 106 via a wheel chair.

Stethoscope 148 may operate to determine and communicate acoustic information for medical analysis. Non-limiting examples of types of stethoscope for stethoscope 148 include telephonic and Internet protocol.

EKG equipment portion 150 may operate to determine and communicate electrical heart activity information. Blood pressure cuff 152 may operate to determine and communicate blood pressure information. Cabinet 154 may operate to store equipment and devices when not in use. Temperature monitor 156 may operate to determine and communicate temperature measurements. Non-limiting examples for temperature monitor 156 include infrared. Oximeter 158 may operate to determine and communicate oxygen saturation of blood. Spirometer 160 may operate to determine and communicate air volume as inspired and expired. Glucose monitor 162 may operate to determine and communicate concentration of glucose in blood.

Second camera 164 may operate to provide close-up information for a patient and associated devices. Second camera 164 may be affixed to a flexible boom in order to orient second camera 164 for viewing a user's/patient's body features or equipment associated with tele-health cabin 106 and monitor 166 which allows the patient to position camera 164 to the correct place so that the remote nurse practitioner can instruct the camera 164 to transmit a still image of the desired are of the patient's body to the MCC. Non-limiting examples of information provided include views of patient's skin, blood pressure cuff 152, temperature monitor 156, oximeter 158, spirometer 160 and glucose monitor 162.

Presence detector 168 may operate to determine and communicate the presence or lack presence of a user or patient. Non-limiting examples of uses for presence detector 168 include start of consultation session and end of consultation session. Non-limiting examples of presence detector 168 include motion and infrared.

Coat hanger 170 may operate to provide a location for clothing and for communicating the presence or lack of presence of clothing. Non-limiting examples of uses for coat hanger 170 include notifying a user or patient when an article of clothing should be retrieved from coat hanger 170 following a consultation. As a non-limiting example, coat hanger 170 may operate via a pressure switch.

Video display 184 may operate to receive and present information for external users and patients. Non-limiting examples of information provided includes occupancy status and queue reference number.

Panic device 186 may operate to provide a mechanism for a user or patient to initiate a warning notification. Siren 188 may operate to receive information from panic device 186 for generating a warning notification.

Seat 146 may provide vital signs monitoring devices encapsulated in the seat back. Cabinet 154 may provide storage for vital signs monitoring devices when not in use. Digital scale 112 and height measurement device 114 may be located external to tele-health cabin 106 and may be located in close proximity to terminal 116. Electronic devices and equipment may transmit and receive information from satellite transceiver 108. Satellite transceiver may communicate bi-directionally with satellite antenna 110 via a communication channel 109.

Two way videoconference and data communications may be provided between tele-health cabin 106 and MCC 104 via satellite communications system 102.

Processing system 178 may operate to communicate bi-directionally with remote satellite teleport 174 via a communication channel 176.

A user/patient may operate to initiate and communicate bi-directionally by videoconference call to a medical professional using remote terminal 180.

Alternatively, tele-health cabin 106 and MCC 104 may bypass satellite communications system 102 and communicate bi-directionally via a terrestrial communications network 182.

In operation, a user or patient seeking to receive medical care via tele-health cabin 106 may purchase access. Non-limiting examples of methods for purchasing access include smart card, credit card, debit card and cash. Non-limiting examples of facilities for purchasing access include service desk and kiosk. User or patient may initiate access to medical care via terminal 116. Terminal 116 may be located and accessed external to tele-health cabin 106. User or patient may insert access card into card terminal 120 in order to gain access to tele-health cabin 106. Furthermore, user or patient may enter personal information associated with desired medical treatment via a touch screen provided via terminal 116. Non-limiting examples of information selected by user or patient include language and gender for health care provider.

Furthermore, user or patient may scan, process and communicate bar coded prescription information located on medicine containers via code scanner 118.

Following entry of personal information via terminal 116, a user may remove card device from card terminal 120 and may insert card device into card reader 122. For a determination of a valid card device, door 128 may automatically open via electromechanical means permitting user/patient to enter tele-health cabin 106. Furthermore, following entry of user/patient into tele-health cabin 106, door 128 may automatically close.

Following entry of personal information via terminal 116, a user/patient may be informed via terminal 116 of an occupied or unavailable tele-health cabin 106 and user/patient may be advised to retrieve vibrating page device 126 in order to be notified of the occurrence of an available or vacant tele-health cabin 106. A multiplicity of vibrating page device 126 may be mounted on the wall near door 128. Vibrating page device 126 may operate to enable a user/patient to perform other functions for an occupied or unavailable tele-health cabin 106. Non-limiting examples of other functions which may be performed include shopping and banking A user/patient making use of vibrating page device 126 may be notified when to return in order to gain access to tele-health cabin 106

After entering personal information via terminal 116, a user may be presented with a queue reference number for gaining access to tele-health cabin 106. Furthermore, video display 184 may operate to present the queue reference number of the current user/patient being or to be given services via tele-health cabin 106. Furthermore, video display 184 may operate to present a notification of an available tele-health cabin 106 which may be occupied for services.

For a user/patient making use of a wheelchair, door 128 may automatically be operated via an electromechanical means following a user/patient inserting a valid card device into card reader 122. Furthermore, door 128 may automatically close following entry of a user/patient into tele-health cabin 106. Furthermore, a user/patient making user of a wheelchair may rotate the wheelchair in order to position the wheelchair in front of video terminal 144.

A user/patient may initiate service by inserting card device into card terminal 124. An able bodied user/patient may pull down seat 146 for sitting.

An informational video may be displayed via video terminal 144 in order to present user/patient with information associated with the forthcoming virtual consultation.

Information associated with user/patient may be communicated via satellite to a medical practitioner served by MCC 104. Non-limiting examples of information communicated includes audio, video, images and patient vital signs. Video information associated with user/patient may be captured and transmitted via video camera 145. Audio information associated with user/patient may be capture and transmitted via microphone 147.

Software may operate to process information for generating tele-health three-dimensional wire-frame figure which may be displayed as a PIP (Picture in Picture) image on remote terminal 180 of MCC 104. Non-limiting examples of information used for generating three-dimensional wire-frame figure include data retrieved from card device and data retrieved from instrumentation provided by tele-health cabin 106. Three-dimensional wire-frame figure may operate to provide indicators associated with user/patient. Non-limiting examples of indicators include graphically rendering the Body Mass Index (BMI) of the user and, by use of color coding, displaying a color coded representation of areas of the user's or patient's body which may be affected as a result of prescription drugs being consumed. Furthermore, areas of the user's or patient's body associated with a reported ailment may be presented.

Following the viewing of an informational video presented via video terminal 144, a videophone call may automatically be established between user/patient via video terminal 144 and medical practitioner via remote terminal 180 of MCC 104.

During a videophone call a medical practitioner may request a user/patient orient second camera 164 for viewing portions of a user's/patient's skin or other body features and the patient may use monitor 166 to position camera 164 to the correct place. Furthermore, a medical practitioner may request a user/patient attach vital signs monitoring (VSM) devices the user/patient. Non-limiting examples of VSM devices include blood pressure cuff 152, temperature monitor 156, oximeter 158, spirometer 160, and glucose monitor 162. VSM devices may be stored in cabinet 154. Furthermore, VSM devices may be connected via retractable cables enabling easy access, retrieval and storage by user/patient.

A medical practitioner may request a user/patient orient their body position such that the medical practitioner may operate to remotely control the position of the electromechanically operated seat back of seat 146. A medical practitioner may configure seat 146 such that stethoscope 148 and EKG equipment portion 150 make contact through a layer of clothing with the back portion of user/patient.

Data received from one or more VSM devices attached to the user/patient may automatically be transmitted from tele-health cabin 106 via satellite communications system 102 to MCC 104. Furthermore, a medical practitioner may view the received information via remote terminal 180. Non-limiting examples for the received information presented via remote terminal 180 include data overlaid as text and graphics on a three dimensional view of user's/patient's body image.

Following consultation with user/patient, a medical practitioner may perform further actions associated with user/patient residing in tele-health cabin 106. Non-limiting examples of actions performed by medical practitioner include making diagnosis of the health problem for user/patient, transmit medical prescription electronically for the user/patient to a nearby pharmacy, place electronic rendition of prescription on user's/patient's card device, place an electronic rendition of a medical test request on user's/patient's card device, conduct further examinations in follow-on tele-health session(s) and/or refer the user/patient to a participating hospital, clinic or specialist for further treatment. Non-limiting examples of activities a user/patient may perform following a tele-health session include user/patient receiving medications for associated prescriptions received in tele-health session, participating in medical tests via diagnostic laboratory and/or visiting clinic, hospital, etc. for further treatment. Furthermore, results of tele-health session and follow-on activities may be stored on card device.

Sanitization device 132 may operate to perform sanitization of the air located inside tele-health cabin 106 and may operate to perform sanitization of interior surfaces of tele-health cabin 106. Air management device 136 may operate to sanitize air entering tele-health cabin 106. Non-limiting examples for operation of air management device 136 include ultraviolet light irradiating on strips of rare metals. As an example, the air and interior surfaces of tele-health cabin 106 may be sanitized over 30 times per hour in order to minimize the risk of contagious diseases being transmitted between users/patients.

Cameras portion 140, used in conjunction with ultraviolet light 142, may operate to detect a soiled floor 130. Cameras portion 140 may operate to take photographs of cabin floor 130 illuminated via ultraviolet light 142 and detect contaminants. Floor 130 may be printed with a special pattern for enabling detection of contaminants located on floor 130. The contaminant detection system as denoted by cameras portion 140 and ultraviolet light 142 is described in U.S. Provisional Patent Application U.S. 61/327,637 previously filed on Apr. 23, 2010 by the applicants for the present invention. The contents of this related provisional application are incorporated herein by reference for all purposes to the extent that such subject matter is not inconsistent herewith or limiting hereof

For detection of a condition of contamination for floor 130 via cameras portion 140 and ultraviolet light 142, a user/patient maybe charged a fee for cleaning tele-health cabin 106. Furthermore, tele-health cabin 106 may operate to notify a third party of tele-health cabin 106 needing cleaning.

In order to prevent interference between light device 138 and video terminal 144, the operational frequency of light device 138 may be dissimilar from the operational frequency of the camera associated with video terminal 144.

Auxiliary power may be provided to light device 138 via an Uninterruptible Power Supply. Uninterruptible Power Supply may operate to maintain power to light device 138 following a power failure.

Cabin management system in conjunction with coat hanger 170 may operate to warn a user/patient in the process of exiting tele-health cabin 106 that the user/patient has not taken their item(s) of clothing with them. Furthermore, cabin management system 134 may also provide a warning notification to MCC 104 regarding the status of coat hanger 170.

Panic device 186 may be activated in an emergency in order to operate siren 188 for summoning assistance from external sources.

Presence detector 168 may be provided in order to detect the condition of a user/patient failing to exit tele-health cabin 106 following a virtual consultation session.

Cabin management system 134 may communicate with equipment and sensors associated with tele-health cabin 106. Furthermore, cabin management system 134 may communicate with MCC 104. Furthermore, remote terminal 180 may receive information from cabin management system 134 associated with equipment and sensors associated with tele-health cabin 106.

A virtual switch may be provided via remote terminal 180 of MCC 104 for enabling a medical professional with the capability to remotely activate door 128. A non-limiting example of a situation where a medical professionally may operate to activate door 128 includes a condition of emergency.

Card device associated with card terminal 120 may operate as a debit or pre-paid card in order to charge for services rendered via tele-health cabin 106. Non-limiting examples of services debited from card device include video consultations and other associated consultation fees.

Tele-health cabin 106 may communicate via terrestrial communications network 182 with a database (not shown) of product information associated with commercial establishments hosting tele-health cabin 106. Non-limiting examples of commercial establishments include grocery stores, supermarkets and shopping malls. Tele-health cabin 106 in conjunction with the commercial establishment's database may operate to provide electronic coupons on user's/patient's card device. Coupons provided may be associated with diagnoses related to tele-health cabin 106 consultation. User/patient may view coupons deposited on card device following exit from tele-health cabin 106 by inserting the card device into card terminal 120.

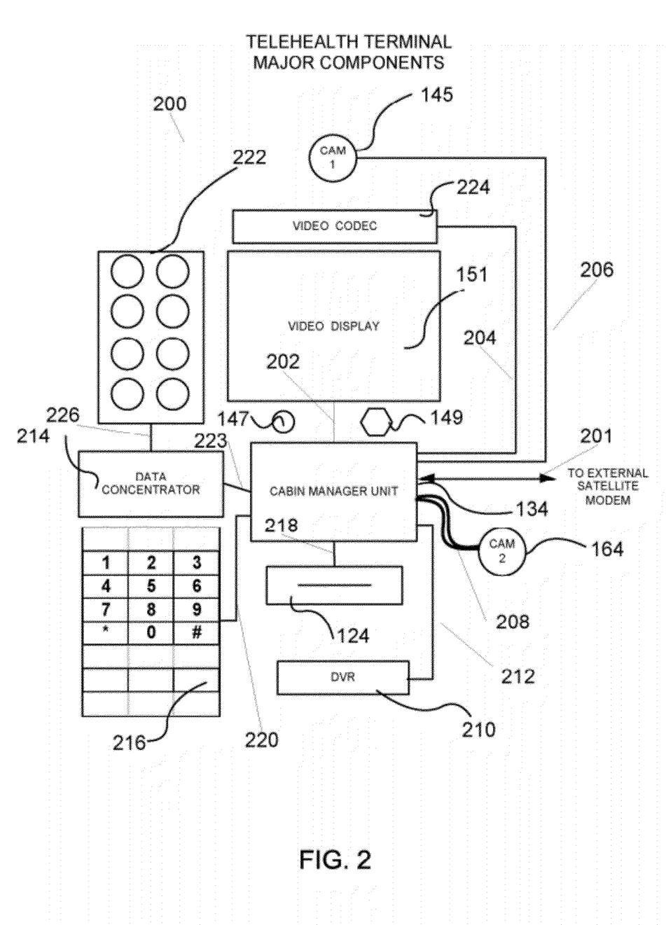

FIG. 2 presents an example schematic illustration for a system associated with tele-health cabin 106 (FIG. 1), in accordance with an embodiment of the present invention.

A system 200 includes card terminal 124 (FIG. 1-2), cabin management system 134 (FIG. 1-2), video camera 145 (FIG. 1-2), microphone 147 (FIG. 1-2), audio portion 149 (FIG. 1-2), video display 151, second camera 164 (FIG. 1-2), a digital recorder 210, a data concentrator 214, a keypad 216, a vital signs portion 222 and a video codec 224.

Digital recorder 210 may operate to record information for later processing and/or use. Non-limiting examples of information recorded via digital recorder 210 include audio and video.

Data concentrator 214 may operate to process and organize information associated with vital signs for user/patient.

Keypad 216 may operate to receive alphanumeric and control input information from a user/patient.

Vital signs portion 222 may operate to interface with vital sign monitoring devices and sensors. Non-limiting examples of devices and sensors interface via vital signs portion 222 include stethoscope 148 (FIG. 1), EKG equipment portion 150 (FIG. 1), blood pressure cuff 152 (FIG. 1), temperature monitor 156 (FIG. 1), oximeter 158 (FIG. 1), spirometer 160 (FIG. 1) and glucose monitor 162 (FIG. 1).

Video codec 224 may operate to code and decode video information.

Cabin management system 134 (FIG. 1-2) may communicate bi-directionally with external communications and networking equipment via a communication channel 201, with video display 151 (FIG. 1-2) via a communication channel 202 with video codec 224 via a communication channel 204, with video camera 145 (FIG. 1-2) via a communication channel 206, second camera 164 (FIG. 1-2) via a communication channel 208, with digital recorder 210 via a communication channel 212, with card terminal 124 via a communication channel 218, with keypad 216 via a communication channel 220 and with data concentrator 214 via a communication channel 223. Data concentrator 214 may communicate bi-directionally with vital signs portion 222 via a communication channel 226.

Cabin management system 134 (FIG. 1-2) may operate as a central processor and communications hub for tele-health system 200. Cabin management system 134 (FIG. 1-2) may operate to control the operation of and communication with video codec 224, video display 151 (FIG. 1-2), video camera 145 (FIG. 1-2), microphone 147 (FIG. 1-2), audio portion 149 (FIG. 1-2) and video display 151 (FIG. 1-2) associated with video terminal 144 (FIG. 1).

Cabin management system 134 (FIG. 1-2) may operate to control the operation of and communication with second camera 164 (FIG. 1-2). Furthermore, cabin management system 134 may operate to control the operation of and communication with vital signs portion 222 for performing data acquisition via data concentrator 214.

Cabin management system 134 (FIG. 1-2) may operate to control the operation of and communication with keypad 216 for receiving data input from user/patient.

Cabin management system 134 (FIG. 1-2) may operate to control the operation of and communication with card terminal 124 (FIG. 1-2) for reading customer information and storing information to a card device. Furthermore cabin management system 134 (FIG. 1-2) may communicate information received from MCC 104 for storage to card device via card terminal 124 (FIG. 1-2).

Cabin management system 134 (FIG. 1-2) may operate to control the presentation out of instructional videos stored on digital recorder 210.

Cabin management system 134 (FIG. 1-2) may operate to control the operation of and communication with video codec 224 for coding and decoding of video between video camera 145 (FIG. 1-2), second camera 164 (FIG. 1-2) and/or the satellite transceiver 108 (FIG. 1).

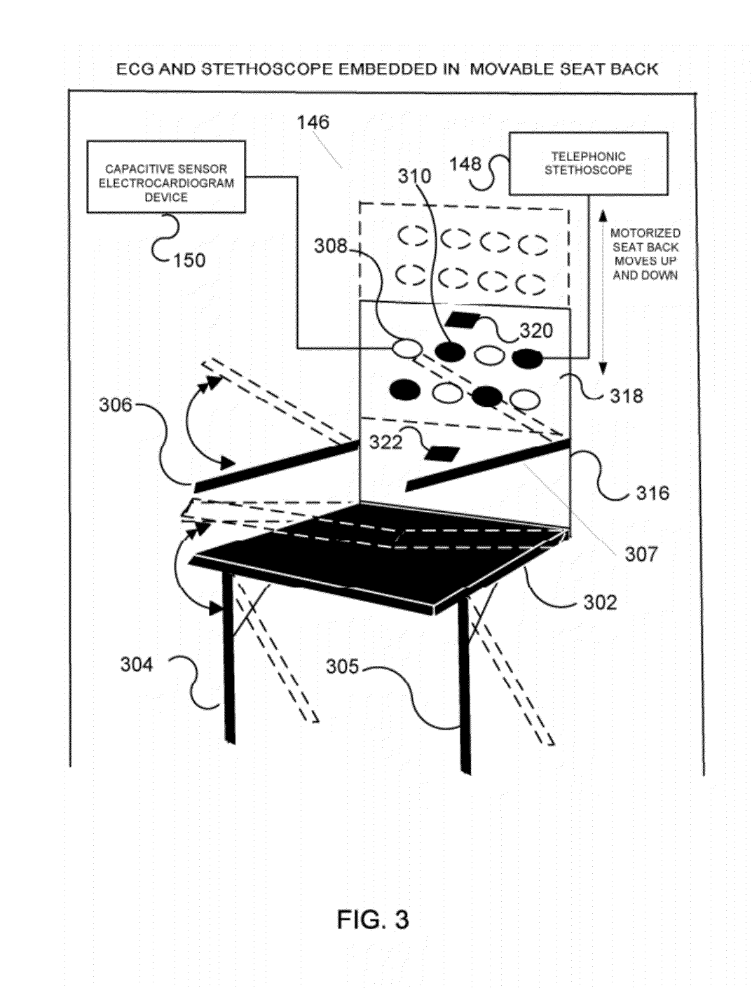

FIG. 3 presents an example illustration of a folding seat located within a tele-health cabin, in accordance with an embodiment of the present invention.

Seat 146 (FIGS. 1, 3) includes a folding leg 304, a folding leg 305, a folding arm 306, a folding arm 307, a multiplicity of sensors with a sampling denoted as a sensor 308, a multiplicity of audio sensors with a sampling denoted as an audio sensor 310, a back 316,] a sitting portion 302, an electric motor 320, an electric motor 322, stethoscope 148 (FIGS. 1, 3) and EKG equipment portion 150 (FIGS. 1, 3).

Seat 146 (FIGS. 1, 3) may operate to fold against the wall of tele-health cabin 106 (FIG. 1) when not in use. Furthermore, Seat 146 (FIGS. 1, 3) may operate to fold against the wall of tele-health cabin 106 (FIG. 1) in order to permit space for wheelchair access.

Folding leg 304, folding leg 305, folding arm 306 and folding arm 307 may fold or collapse when operating folding seat 146 to fold against wall of tele-health cabin 106 (FIG. 1).

A multiplicity of sensors with a sampling denoted as sensor 308 may be located in back 316. Non-limiting examples for sensor 308 include capacitive sensors.

EKG equipment portion 150 (FIG. 1) may connect to sensors for measuring user/patient associated information. Non-limiting examples of measured information includes human heart functions. Furthermore, measurements recorded by sensor 308 may be performed through one layer of clothing.

A multiplicity of audio sensors with a sampling denoted as audio sensor 310 may be located in back 316. Audio sensors may be connected to stethoscope 148 (FIG. 1) for measuring the sound of blood traversing through a user/patient. Non-limiting examples of portions of a human body measured via audio sensors includes arteries, veins and heart. Audio sensors may operate to measure information through one layer of a user's/patient's clothing. Furthermore, information measured via audio sensors and stethoscope 148 (FIG. 1) may be communicated to MCC 104 (FIG. 1).

Back 316 may be configured via electric motor 320 and electric motor 322 and other mechanical devices in order to enable a medical practitioner with the capability to activate electric motors 320 and 322 and as a result transition seat back 316 up, down, left or right. Back 316 may be configured by medical practitioner such that sensors may contact with a user's/patient's back in an appropriate location.

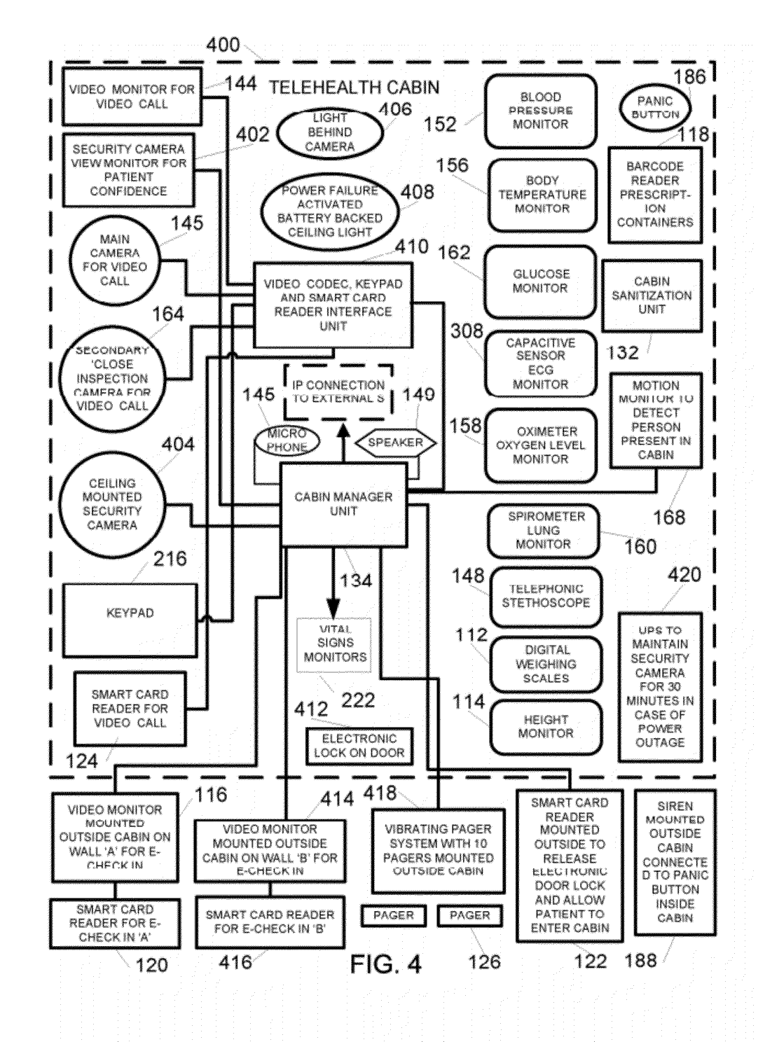

FIG. 4 presents an example illustration of a system of electronic components associated with tele-health cabin 106 (FIG. 1).

A system 400 includes video terminal 144 (FIGS. 1, 2, 4), a security camera monitor 402, video camera 145 (FIGS. 1, 2, 4), second camera 164 (FIGS. 1, 2, 4), a security camera 404, keypad 216 (FIG. 2), card terminal 124 (FIGS. 1, 4), terminal 116 (FIG. 1), card terminal 120 (FIG. 1), a light 406, a back-up light 408, an interface unit 410, microphone 147 (FIG. 1), audio portion 149 (FIG. 1), cabin management system 134 (FIG. 1), vital signs portion 222 (FIG. 2), a door lock 412, a terminal 414, a card terminal 416, a paging system 418, a multiplicity of vibrating page devices with a sampling denoted as vibrating page device 126 (FIG. 1), blood pressure cuff 152 (FIG. 1), temperature monitor 156 (FIG. 1), glucose monitor 162 (FIG. 1), sensor 308, oximeter 158 (FIG. 1), spirometer 160 (FIG. 1), stethoscope 148 (FIG. 1), digital scale 112 (FIG. 1), height measurement device 114 (FIG. 1), card reader 122 (FIG. 1), panic device 186 (FIG. 1), code scanner 118 (FIG. 1), sanitization device 132 (FIG. 1), presence detector 168 (FIG. 1), a backup power device 420 and siren 188 (FIG. 1).

Security camera monitor 402 may operate to present a view of the user/patient to the user/patient. so that if the user/patient attempts to damage the equipment or cabin structure then security personnel can be alerted and take appropriate action.

Security camera 404 may operate to capture and present a video representation of the internal view of tele-health cabin 106 to security camera monitor 402. Non-limiting examples for mounting or placement of security camera 404 include ceiling of tele-health cabin 106 (FIG. 1).

Light 406 may operate to provide lighting for internal area of tele-health cabin 106 (FIG. 1).

Back-up light 408 may operate to provide light illumination internal to tele-health cabin 106 (FIG. 1) in the event of a primary power failure.

Interface unit 410 may operate to provide control of and communications with various electronic equipment and sensors associated with tele-health cabin 106 (FIG. 1). Non-limiting examples of equipment include video codec, keypad and card terminals.

Door lock 412 may operate to provide a locking mechanism for tele-health cabin 106 (FIG. 1). Non-limiting examples for door lock 412 include electronic, electromechanical and automatic. Door lock 412 may be controlled via card reader devices and personal associated with MCC 104 (FIG. 1).

Terminal 414 may operate to provide similar features as described with reference to terminal 116 (FIG. 1).

Card terminal 416 may operate to provide similar features as described with reference to card terminal 120 (FIG. 1).

Paging system 418 may operate to provide notification information to users/patients.

Backup power device 420 may operate to provide power to tele-health cabin 106 (FIG. 1) in the event primary power fails to be provided.

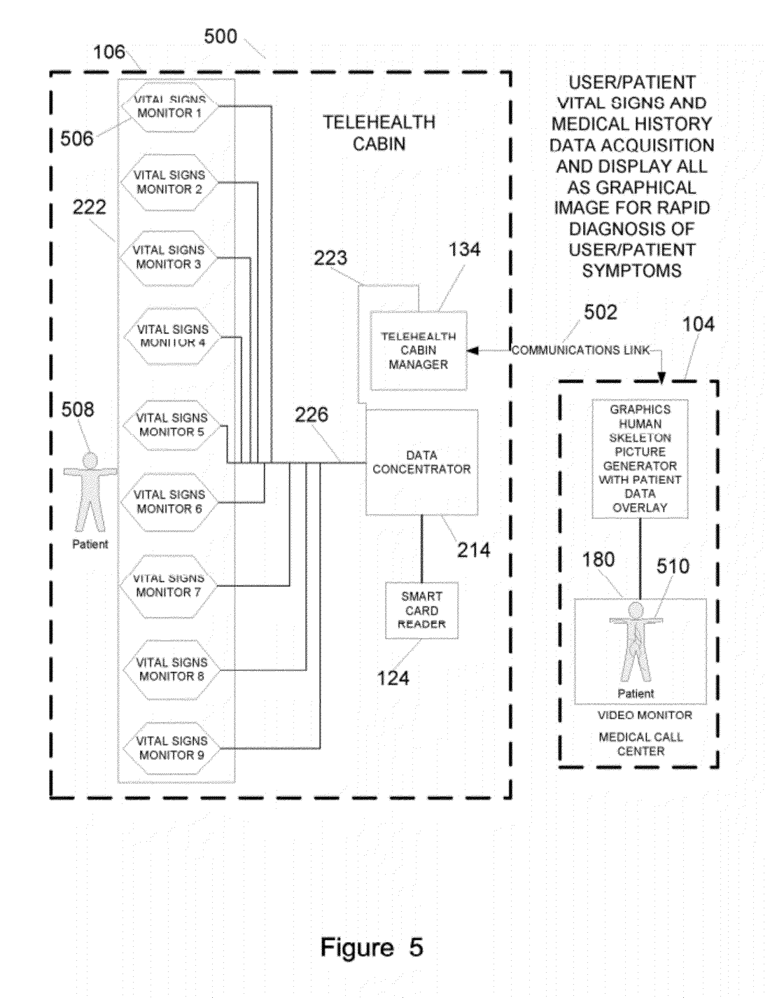

FIG. 5 presents an example schematic illustration of a tele-health system, in accordance with an embodiment of the present invention.

A tele-health system 500 includes tele-health cabin 106 (FIG. 1) and MCC 104 (FIG. 1).

Tele-health cabin 106 (FIG. 1) may communicate bi-directionally with MCC 104 (FIG. 1) via a communications channel 502. Non-limiting examples of communications channel 502 include satellite, cellular, wireless and terrestrial.

Tele-health cabin 106 (FIG. 1) includes cabin management system 134 (FIG. 1), data concentrator 214 (FIG. 2), card terminal 124 (FIG. 1) and vital signs portion 222 (FIG. 2).

Vital signs portion 222 (FIG. 2) includes a multiplicity of vital sign monitors with a sampling denoted as a vital sign monitor 506.

Vital sign monitor 506 may operate to measure and communicate vital sign information associated with a user/patient 508. Non-limiting examples of vital sign monitors include blood pressure, blood oxygen content, respiration, blood glucose and EKG.

Data concentrator 214 (FIG. 2) may operate to receive vital sign information from vital signs portion 222 (FIG. 2) and receive information associated with user/patient via card device presented to card terminal 124 (FIG. 1). Data concentrator 214 (FIG. 2) may process received information from vital sign monitor 506 and card terminal 124 (FIG. 1) and communicate processed information to cabin management system 134 (FIG. 1).

Cabin management system 134 (FIG. 1) may communicate information received from data concentrator 214 (FIG. 2) to MCC 104 (FIG. 1) via communications channel 502.

MCC 104 (FIG. 1) may operate to receive and process information from cabin management system 134 (FIGS. 1, 2) and present an information display 510 for viewing by a medical professional via remote terminal 180 (FIG. 1). Non-limiting examples of information display 510 include video, audio, text and images. Information display 510 may be processed and presented in a real-time manner such as to display an animated graphical profile of the user's/patient's body on avatar with layered overlays illustrating information associated with user/patient. Non-limiting examples of information presented include cardiac, digestive, respiratory and circulatory paths in such a manner as to allow the medical professional associated with MCC 104 to be able to make a diagnosis of the medical condition for user/patient 508. Furthermore, as a result of information display 510 received, medical professional may operate to further advance treatment of user/patient 508.

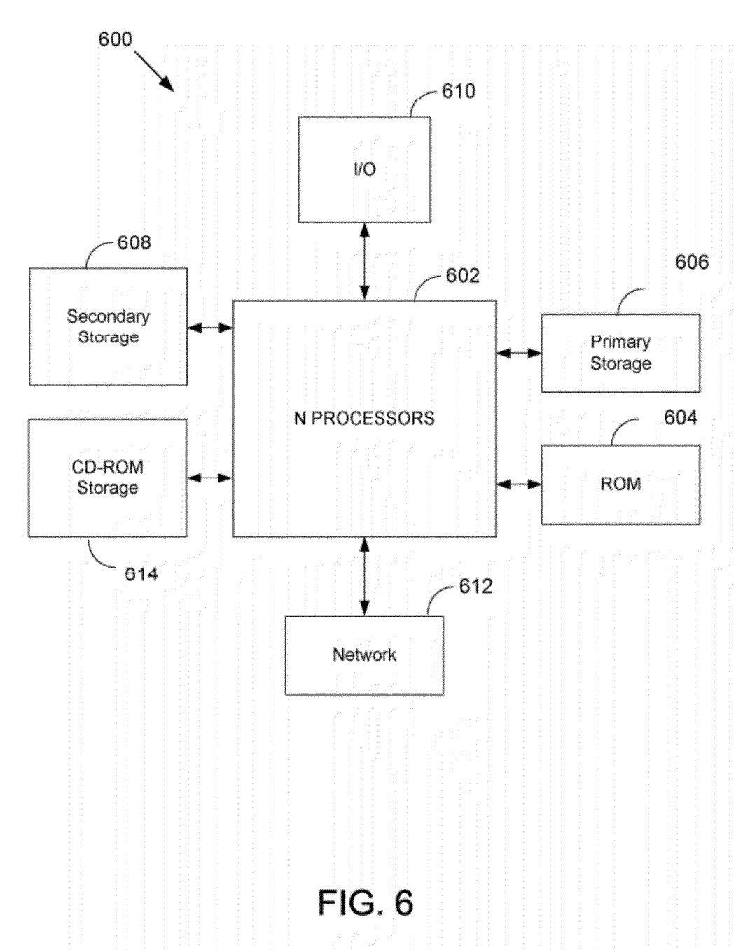

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

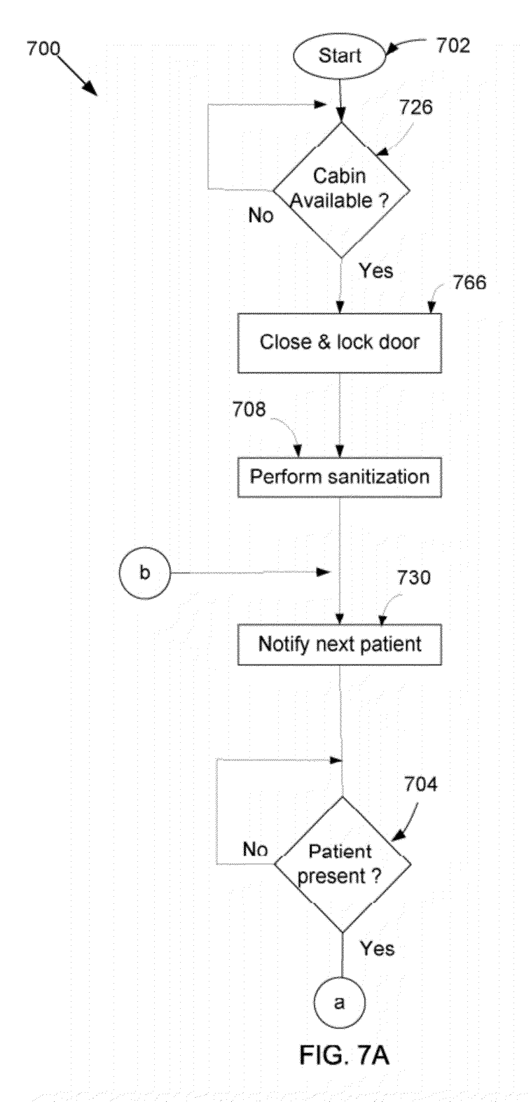

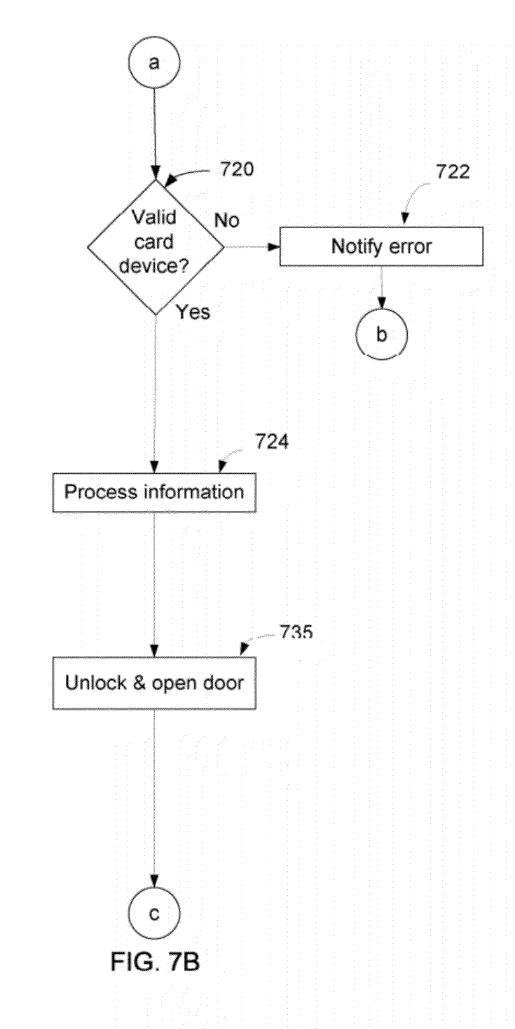

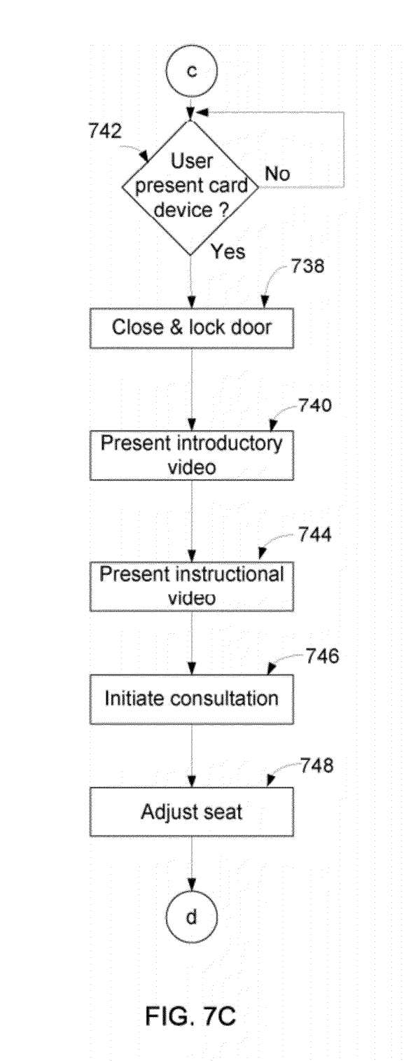

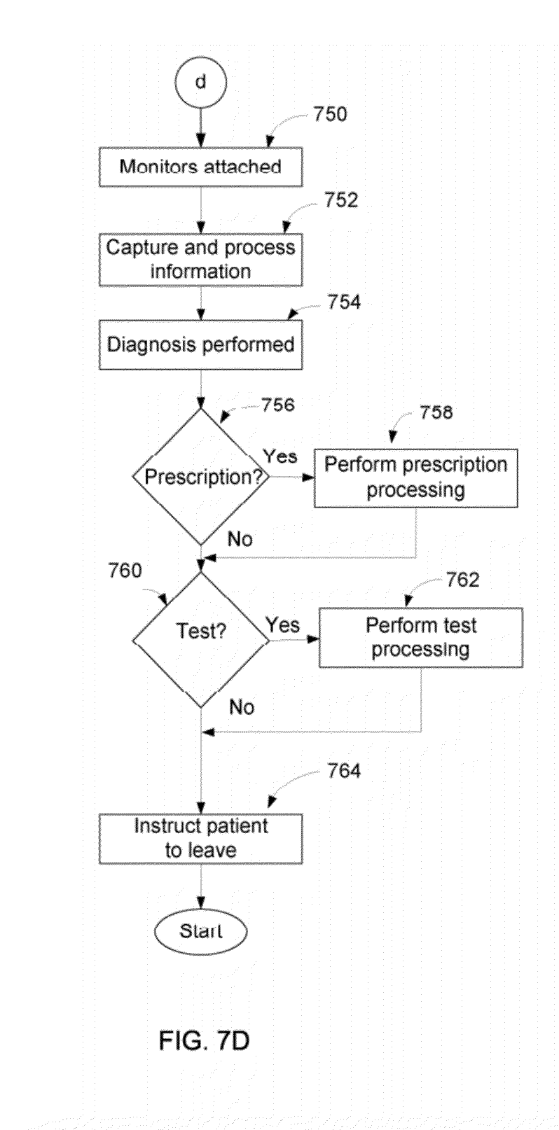

FIGS. 7A-D present a flow chart illustrating an exemplary method 700 for interaction with the elements as described with reference to FIGS. 1-6, in accordance with an embodiment of the present invention.

For method 700, the process initiates in a step 702 (FIG. 7A).

A determination of an available tele-health cabin 106 (FIG. 1) may be performed in a step 726.

In a step 766 the door 128 (FIG. 1) may be closed and locked via door lock 412 (FIG. 4). Following closing and locking door in step 766, execution of method 700 transitions to step 708.

Sanitization is performed in a step 708. To perform sanitization, cabin management system 134 (FIG. 1), after detecting unsanitary condition, may configure sanitization device 132 (FIG. 1) to perform sanitization of tele-health cabin 106 (FIG. 1).

The next available user/patient may be notified via paging system 418 (FIG. 4) and vibrating page device 126 (FIG. 1) in a step 730.

The systems will wait for a predetermined time for the next patient and a determination of no user present in step 704 after which the next available patient will notified as in the previous step.

In step 720 (FIG. 7B) a determination for a valid card device may be performed. For a determination of an invalid card device in step 720, user may be notified of an error in a step 722 followed by transition of method 700 to step 730 (FIG. 7A).

For a determination of a valid card device in step 720, information presented via card device and via user/patient input may be processed in a step 724.

For a determination of a valid card device in step 732, door 128 (FIG. 1) may be unlocked via door lock 412 (FIG. 4) and automatically opened in a step 735.

For a determination of the presence of a user/patient, in a step 738, door 128 (FIG. 1) may be closed and locked via door lock 412 (FIG. 4).

In a step 740, user/patient may be presented an introductory video via video terminal 144 (FIG. 1).

In a step 742, a determination may be performed to determine if user/patient has presented card device to card terminal 124 (FIG. 1). For a determination of a user/patient presenting card device to card terminal 124 (FIG. 1) in step 742, an instructional video may be presented to user/patient via video terminal 144 (FIG. 1) in a step 744.

In a step 746, a consultation may be initiated between user/patient located in tele-health cabin 106 (FIG. 1) and medical professional associated with MCC 104 (FIG. 1).

In a step 748, seat 146 (FIG. 1) may be adjusted in order to obtain proper orientation of sensors associated with back 316 (FIG. 3) of seat 146 (FIG. 1).

In a step 750 (FIG. 7D), monitoring devices and sensors may be attached to user/patient by user/patient.

In a step 752, information associated with user/patient may be captured, communicated and processed by tele-health cabin 106 (FIG. 1). Furthermore, information may be communicated to remote terminal 180 (FIG. 1) of MCC 104 (FIG. 1) for use by medical professional for determining a diagnosis or determining further steps for treatment.

In a step 754, medical professional associated with MCC 104 (FIG. 1) may perform a diagnosis of user/patient.

In a step 756, a determination of generating a prescription may be performed. For a determination of generating a prescription in step 756, in a step 758 a prescription may be generated. Non-limiting examples of efforts performed for generating a prescription include transmitting prescription information to a pharmacy and/or to user's/patient's card device.

In a step 760, a determination of generating a medical test may be performed. For a determination of generating a medical test in step 760, in a step 762 a medical test may be created. Non-limiting examples of efforts performed for generating a test include transmitting test request to medical test facility and/or to user's/patient's card device.

In a step 764, a determination of the presence of a user/patient may be performed. For a determination of a lack of presence for a user/patient in step 764,

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: satellite network as described with reference to FIG. 1.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing tele-health services according to the present invention will be apparent to those skilled in the art. The invention has been described above by way of illustration, and the specific embodiments disclosed are not intended to limit the invention to the particular forms disclosed. For example, the particular implementation of the organization of a tele-health cabin may vary depending upon the particular type of geographic location or retail establishment used. The hardware and software described in the foregoing were directed to tele-health service implementations; however, similar techniques may be provided for other remotely provide tele-services. Implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
determining an occupancy status of a cabin comprising an enclosure comprising a plurality of vital signs monitoring devices including a blood pressure cuff, a temperature monitor, a spirometer, and an oximeter, a patient chair comprising a plurality of medical sensors including a stethoscope, and an electrocardiograph, a weight scale, a height measurement device, a first video monitor for videoconference calls, a first camera for the videoconference calls, a second camera for skin and orifice inspection, a sanitation device for sanitation of air and interior surfaces of said cabin, an air management device operable for sanitizing air entering the cabin, a presence detector, and a door having an electrically operated lock, said cabin being operable for facilitating health care services;
detecting contaminates on a floor of said cabin;
initiating a sanitation of said cabin using at least said sanitation device when said status is unoccupied and contaminates are detected;
admitting a patient into said cabin by unlocking and opening said door;
initiating a videoconference between the patient and a remote medical practitioner at a medical call center;
capturing data from said plurality of vital signs monitoring devices, plurality of medical sensors, said weight scale, and said height measurement device;
transmitting said captured data to the remote medical practitioner for diagnosis;
processing prescriptions from the remote medical practitioner for the patient; and
processing additional test requests by the remote medical practitioner for the patient.

2. The method as recited in claim 1, further comprising the steps of:
recognizing a card device of a patient; retrieving information from said card device; transmitting at least a portion of said information to the medical call center; and storing results of the diagnosis on said card device.

3. The method as recited in claim 1, further comprising the steps of obtaining medical information from the patient via a terminal adjacent to said cabin and transmitting said information to the medical call center.

4. The method as recited in claim 1, further comprising the steps advising the patient on the availability of the cabin.

5. The method as recited in claim 4, further comprising the steps notifying the patient that the cabin is available.

6. The method as recited in claim 1, further comprising the steps of controlling positioning of said medical sensors in said patient chair in response to commands received from the remote medical practitioner.

7. The method as recited in claim 1, further comprising the steps of displaying an instructional video to the patient.

8. The method as recited in claim 1, in which the step of initiating a sanitization further includes notifying a cleaning attendant.

9. A system comprising:
a cabin comprising:
an enclosure with a door having an electrically operated lock;
means for monitoring vital signs;
means for positioning a plurality of medical sensors including a stethoscope, and an electrocardiograph;
means for weighing a patient;
means for measuring a height of a patient;
means for videoconferencing with a remote medical practitioner;
means operable for skin and orifice inspection;
means operable for detection of contaminants located on a floor of said cabin;
means operable for sanitation of air and interior surfaces of said cabin;
means operable for sanitizing air entering the cabin;
means for detecting a patient within said cabin; and
means for controlling said cabin and capturing patient data from said cabin;
a medical call center comprising:
means for graphically displaying patient data on a three-dimensional representation of a patient; and
means for bi-directional communication between said controlling means and said medical call center enabling said controlling means to transmit said patient data to said medical call center for display on said displaying means to the remote medical practitioner and enabling the remote practitioner to videoconference with a patient in said cabin where the remote medical practitioner can diagnosis symptoms of the patient.

10. A system comprising:
a cabin comprising:
an enclosure with a door having an electrically operated lock;
a plurality of vital signs monitoring devices disposed within said enclosure, said plurality of vital signs monitoring devices including a blood pressure cuff, a temperature monitor, a spirometer, and an oximeter;
a patient chair, disposed within said enclosure, comprising a motorized seat back operable for positioning a plurality of medical sensors including a stethoscope, and an electrocardiograph;
a weight scale for weighing a patient;
a height measurement device for measuring a height of a patient;
a first video monitor, disposed within said enclosure, for videoconference calls to a remote medical practitioner;
a first camera, disposed within said enclosure, for the videoconference calls;
a second camera, disposed within said enclosure, operable for skin and orifice inspection;
a contaminant detection system, disposed within said enclosure, operable for detection of contaminants located on a floor of said cabin;
a sanitation device, disposed within said enclosure, operable for sanitation of air and interior surfaces of said cabin;
an air management device operable for sanitizing air entering the cabin;
a patient presence detector, disposed within said enclosure, for detecting a patient within said cabin; and
a cabin management unit, disposed within said enclosure, for controlling said cabin and capturing patient data from said cabin;
a medical call center comprising:
a second video monitor for graphically displaying patient data on a three-dimensional representation of a patient; and
a communication link for bi-directional communication between said cabin management unit and said medical call center enabling said cabin management unit to transmit said patient data to said medical call center for display on said video monitor to the remote medical practitioner and enabling the remote practitioner to videoconference with a patient in said cabin where the remote medical practitioner can diagnosis symptoms of the patient.

11. The system as recited in claim 10, in which said cabin further comprises a card device reader for reading information from the patient's card device.

12. The system as recited in claim 10, in which said cabin further comprises a terminal for obtaining medical information from the patient.

13. The system as recited in claim 10, in which said cabin further comprises a reader for reading prescription containers.

14. The system as recited in claim 10, in which said cabin further comprises a security camera.

15. The system as recited in claim 10, in which said cabin further comprises pagers for notifying patients of availability of said cabin.

16. The system as recited in claim 10, in which said cabin further comprises a panic button for activating an alarm.

17. The system as recited in claim 10, in which the remote medical practitioner is further enabled to control said motorized seat back for positioning said medical sensors.

18. The system as recited in claim 10, in which the remote medical practitioner is further enabled to unlock and open the door.

19. The system as recited in claim 10, in which said floor comprises a pattern for facilitating detection of contaminants.

20. The system as recited in claim 10, in which said patient chair is foldable.
